(19) United States
(12) Patent Application Publication
(10) Pub. No.: US 2009/0321595 A1
(43) Pub. Date: Dec. 31, 2009

(54) SHELF FRONT DISPLAY MOUNT

(75) Inventors: Thomas M. Conway, Park Ridge, IL (US); Scott Padiak, Glencoe, IL (US); Fred G. Geiger, Glenview, IL (US)

Correspondence Address: LEVENFELD PEARLSTEIN, LLC (CORMARK), 2 N. LASALLE STREET, SUITE 1300, CHICAGO, IL, 60602, US

(73) Assignee: CORMARK, INC., De Plaines, IL (US)

(21) Appl. No.: 12/485,739

(22) Filed: Jun. 16, 2009

Related U.S. Application Data
(60) Provisional application No. 61/061,686, filed on Jun. 16, 2008.

(51) Int. Cl. A47B 96/06; G09F 23/00; G09F 17/00; F16B 47/00

(52) U.S. Cl. 248/205.3; 248/231.81; 40/1; 248/227.2

(57) ABSTRACT

A shelf front mounting system mounts to the front of industry standard shelving. The shelf front mounting system holds product signage or advertising, strips or spines of merchandise product. The shelf front mounting system includes a flexible clip portion having an upper finger for contacting the shelf lower surface near the front edge of the shelf and a lower detent for engaging the shelf front at about the lower lip.

### CROSS-REFERENCE TO RELATED APPLICATION DATA

The present application claims the benefit of U.S. Provisional Application Ser. No. 61/061,686, filed Jun. 16, 2008.

### BACKGROUND OF THE INVENTION

The present invention is directed to a sign mounting system. More particularly, the present invention pertains to an easily mounted sign mount system for mounting to a shelf front that does not interfere with other shelf attachments.

Hundreds of different types of signs and merchandise display systems are used in retail and commercial settings. Sometimes vertical support elements, or spines having hooks or eyes to receive hooks, are positioned on the front of traditional shelves and are used to display signs or merchandise. These vertical support spines are usually mounted to shelf beams in particular, pre-determined ways, allowing merchants little flexibility in designing sign or merchandise displays.

In addition, many known mounting systems are permanent installations, so that removing and relocating the mounting systems is complicated, if not impossible. Many known sign and merchandise displays are attached to their mounts via screws, hinges, or other mechanical elements, making the vertical display difficult to move and may prevent signs or merchandise located behind the vertical display from being seen or accessed. Even if these sign and merchandise displays can be relocated to other sites, the additional elements needed to effect relocation increase the overall cost of the display as well as the labor required to mount them effectively.

Often, it is desirable to use shelf front displays with product or shelf management systems. These management systems can include, for example, a pair of walls between which product is aligned with a pusher (spring actuated) to “push” product forward on the shelf between the walls. Other management systems are known which also automatically replenish product toward the shelf front. In these management systems, the system hardware is mounted to the shelf surface by fasteners such as screws or clips.

One drawback to known shelf front mounting systems is that they interfere with commonly used product management systems. That is, both the shelf front mounts and the product management system mounts require the use of mounting holes in the top surface of the shelf. As such these displays systems cannot be used together.

One known shelf front mount uses a bottom surface mounting configuration (that still requires use of the shelf holes), but clamps into place on the shelf bottom surface. While this configuration reduces the impact on the usable portion of the shelf, it does not eliminate such impact, and requires the use of costly threaded clamping members to secure the shelf front mount.

Accordingly, there is a need for a shelf front mounting system that can be used in conjunction with known product management systems. Desirably, such a shelf front mount is usable anywhere along a shelf front lip and can be sued with a wide variety of different types of displays. More desirably such a system can be used with a variety of shelf types—that is shelf front types—in a universal manner. More desirably still, such a shelf front mount system permits installation and removal without tools and with product located on the shelf above and below.

### BRIEF SUMMARY OF THE INVENTION

A shelf front mounting system is for use on a shelf having a shelf upper surface, a shelf lower surface and a shelf front depending from a front edge of the shelf at a juncture of the shelf and the shelf front. Such a shelf front has a lower lip.

The mount includes a flexible clip portion having an upper finger for contacting the shelf lower surface near the front edge of the shelf and a lower detent for engaging the shelf front at about the lower lip.

A display portion is integral with the flexible clip portion. The display portion can include a graphics accommodating region. The graphics accommodating region can be formed as a flag. The flag can be vertically oriented and include one or more hooks formed therein for displaying product.

The flexible clip portion has a C-shaped body. Preferably, the clip is formed from a polymeric material. An angled member or tip can be mounted to the upper finger for engaging the shelf at about the juncture of the shelf and shelf front. The tip can be formed from a metal material.

In one embodiment, the clip includes a flange extending from the upper finger. Optionally, the clip can include a flange extending from the upper finger and a flange extending from the lower detent. In such an embodiment, the clip can further include a locking tab flexibly connected to the clip portion between the upper finger and the lower detent. The locking clip includes a forwardly extending projecting configured to engage and secure to a rear surface of the shelf front.

Alternately, the clip portion can include a flange extending from the lower detent and a biasing element such as a spring disposed in the clip between the upper finger and the flange. The spring is disposed to engage and secure to a rear surface of the shelf front. In such an embodiment, a tip can be mounted to the upper finger for engaging the shelf at about the juncture of the shelf and shelf front.

The mount system can be used to support a shelf extender. In such an arrangement, a pair of clip portions are positioned such that the shelf extender is mounted to the pair of clip portions and extends forwardly of the shelf.

These and other features and advantages of the present invention will be readily apparent from the following detailed description, in conjunction with the claims.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 is a perspective view of an embodiment of the shelf front mounting system;

FIG. 2 is an exploded view of the shelf front mounting system illustrating a shelf mounting bracket and a swivel clip;

FIG. 3 is an exploded view of the shelf front mounting system illustrating a shelf mounting bracket and a swivel clip as seen from the rear of the bracket;

FIG. 4 is a side view of the shelf front mounting system;

FIG. 5 is a top view of the shelf front mounting system;

FIG. 6 is a front view of the shelf front mounting system;

FIGS. 7a-7d are various views of the shelf mounting bracket of the shelf front mounting system;

FIGS. 8a-8e are various views of the swivel clip of the shelf front mounting system;

FIGS. 9a-9c are various views of the shelf front mounting system mounted to a shelf front and showing a product strip, with a product thereon, mounted to the system;

FIGS. 10a-10c are various views of the shelf front mounting system mounted to a shelf front having a front channel and having a product strip, with a product thereon, mounted to the system;

FIG. 11 is a side view of the shelf front mounting system mounted to a shelf front without the front channel;

FIG. 12 is an alternate embodiment of the shelf front mounting system illustrated mounted to a shelf front;

FIG. 13 is an exploded view of the alternate embodiment of the shelf front mounting system showing a shelf mounting bracket and a swivel clip;

FIG. 14 is a rear perspective of the alternate embodiment of the shelf front mounting system showing a shelf mounting bracket and a swivel clip;

FIGS. 15a-15d are various views of the shelf mounting bracket used with the alternate embodiment of the shelf front mounting system;

FIG. 16a is a top perspective view showing the bottom of the alternate shelf front mounting system mounted to a shelf;

FIG. 16b is a bottom perspective view of the mount of FIG. 16a;

FIG. 17 is a side view of the alternate embodiment of the shelf front mounting system of FIGS. 16a and b mounted to a shelf;

FIGS. 18a and b are side and front view of an alternate embodiment of the shelf front mount system;

FIGS. 19a-e are still another alternate embodiment of the shelf front mount system;

FIG. 20 is a side view of yet another alternate embodiment of the shelf front mount system;

FIGS. 21a-c are still another alternate embodiment of the shelf front mount system in which the clip wraps around the shelf front; and

FIGS. 22a-c are another alternate embodiment of the shelf front mount shown with a shelf front extender.

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

It should be further understood that the title of this section of this specification, namely, “Detailed Description Of The Invention”, relates to a requirement of the United States Patent Office, and does not imply, nor should be inferred to limit the subject matter disclosed herein.

A shelf front mounting system with a gimbal attachment is designed to attach to the front of industry standard shelving and hold strips or spines of merchandise product or signage. The shelf front mounting system is quickly attached to shelving and requires no tools or hardware for installation. A swivel clip attaches to a shelf mounting bracket to provide a swivel (pivot and rotate) feature to the hanging spines or product strips. The shelf mounting bracket is horizontally and/or vertically slidable along the shelf to which it is attached to provide a user means for repositioning hanging merchandise or signage without interfering with price labels seated on shelf channels. The swivel clip is clockwise and counterclockwise rotatable, as well as pivotable while attached to the shelf mounting bracket.

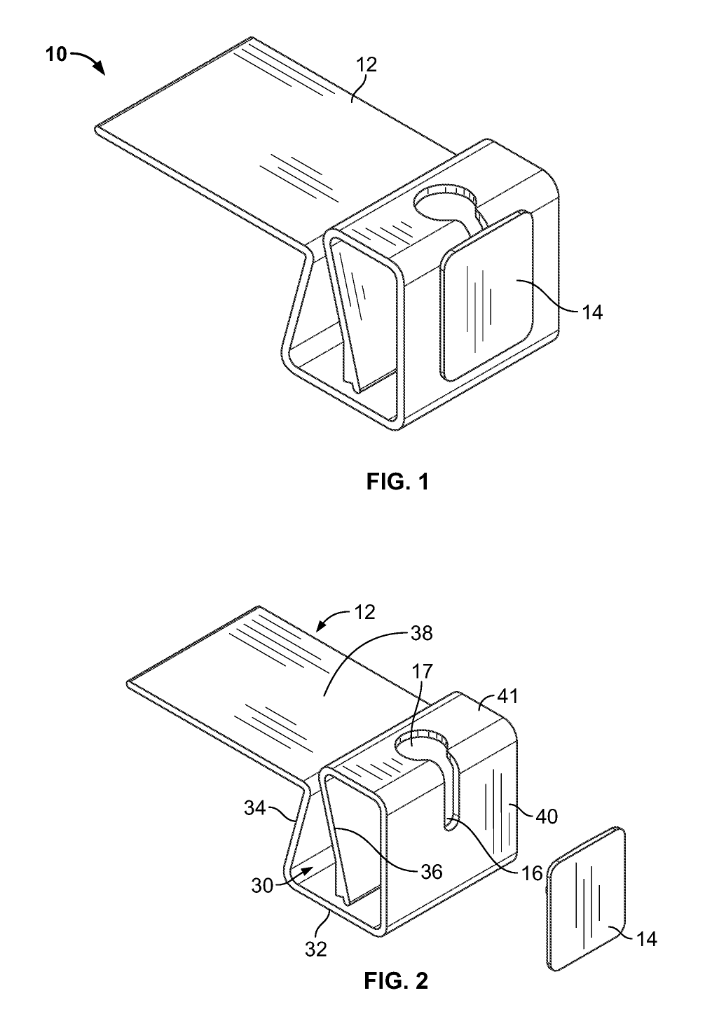

Referring now to the figures and in particular to FIG. 1, there is shown an embodiment of the shelf front mounting system 10. The shelf front mounting system 10 includes a shelf mounting bracket 12 and a swivel clip 14. The mounting bracket 12 and swivel clip 14 may be made from metal or plastic or a combination thereof. Plastics can be formed by injection molding or other manufacturing methods as will be recognized by those skilled in the art.

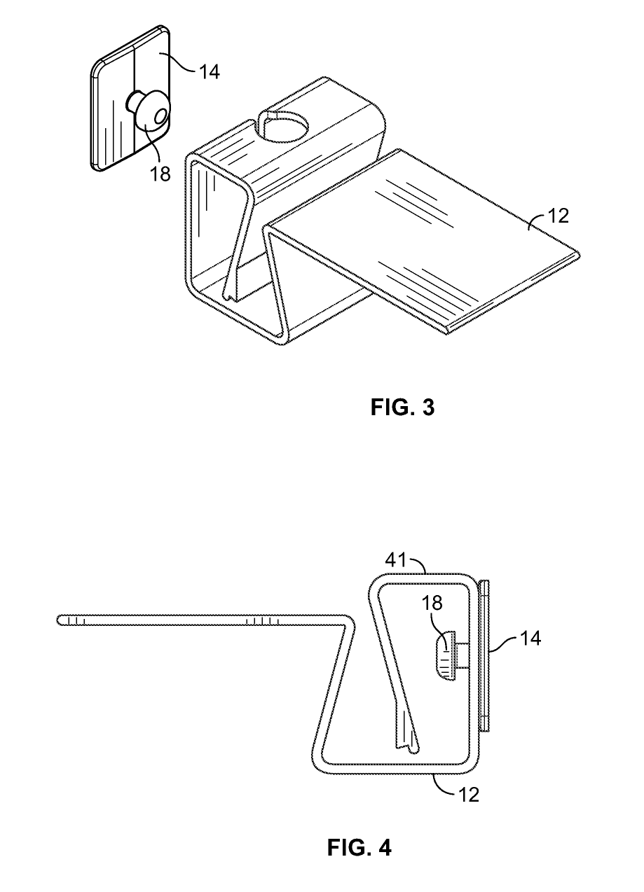

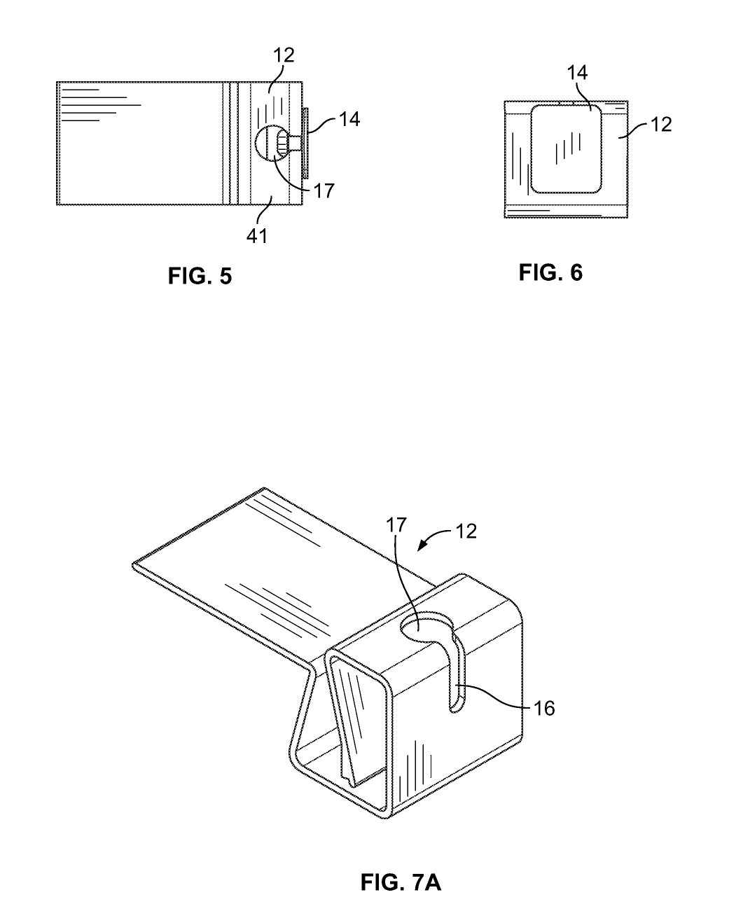

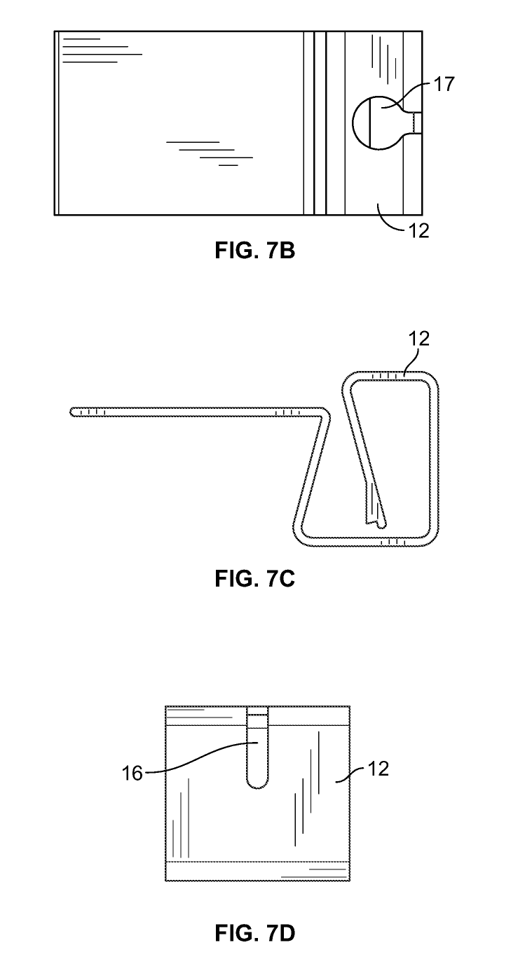

The shelf mounting bracket 12 has a slot 16 into which a gimbal head 18 of the swivel clip 14 is positioned, as shown in FIGS. 2-7a-d. The shelf mounting bracket 12 is preferably a single-piece molded bracket having a channel 30 formed by a bottom wall 32 and two flexible, angled side walls 34, 36. The shelf mounting bracket 12 also includes a brace wall 38 and a front wall 40 contiguous with a top wall 41 through which a slot 16 is formed. The slot 16 is contiguous between the front and top walls 40, 41. The slot 16 includes an enlarged open region 17 in the top wall 41.

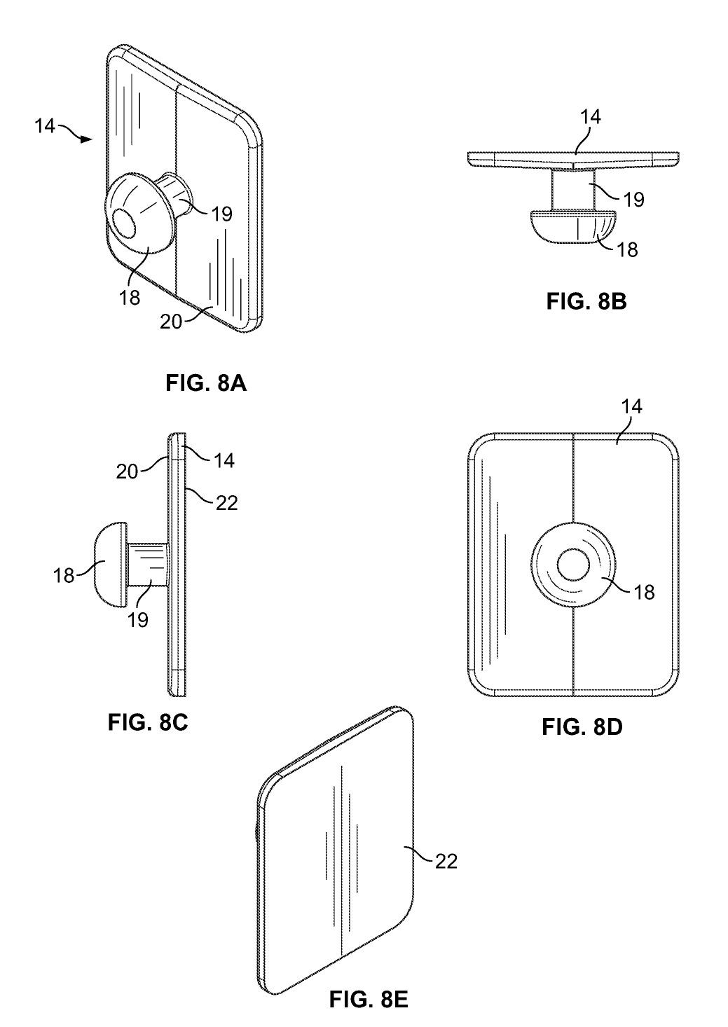

FIGS. 8a-8e illustrate the swivel clip 14. The swivel clip 14 includes a gimbal head 18 and a display wall 20. The gimbal head 18 is mounted to or integral with a first surface 24 of the display wall 20. A second surface 22 of the display wall 20 may include adhesive and/or adhesive material. In a present embodiment, the display wall 20 is a rectangular shaped wall, however, it is anticipated that the display wall 20 to which the gimbal head 18 is connected may have any number of shapes or forms. As illustrated, a stub or shaft 19 connects the gimbal head 18 to the wall 20.

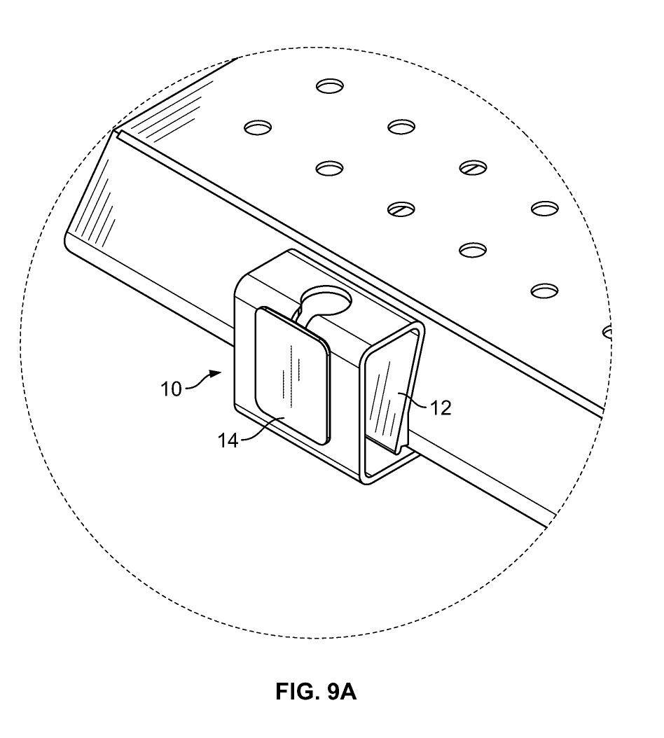

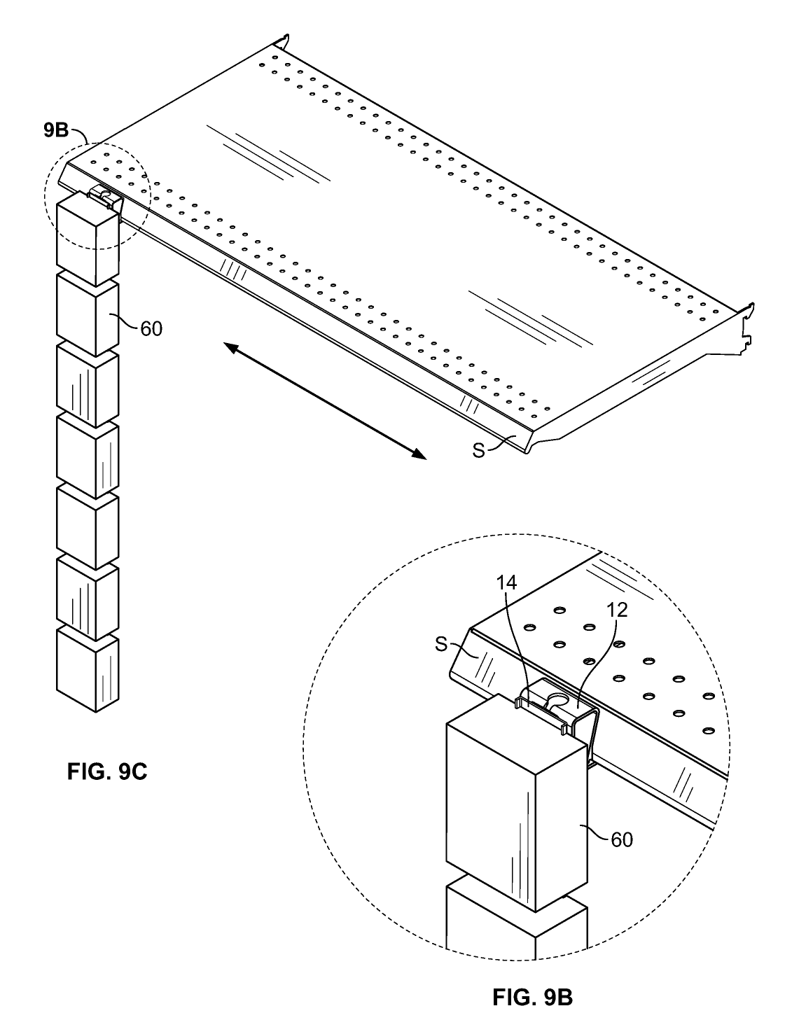

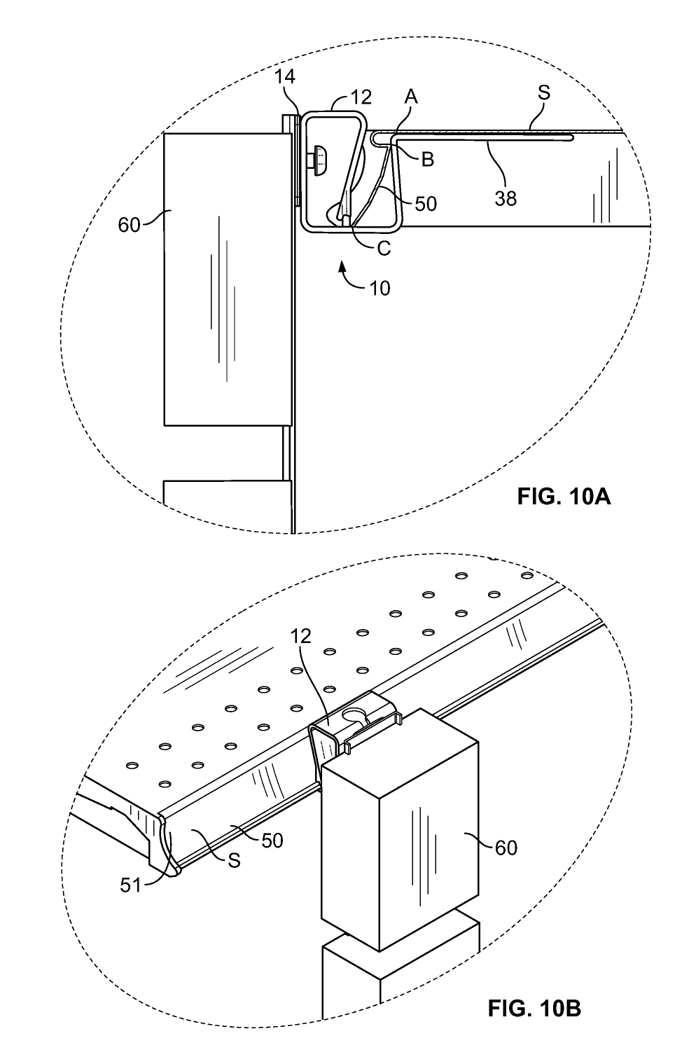

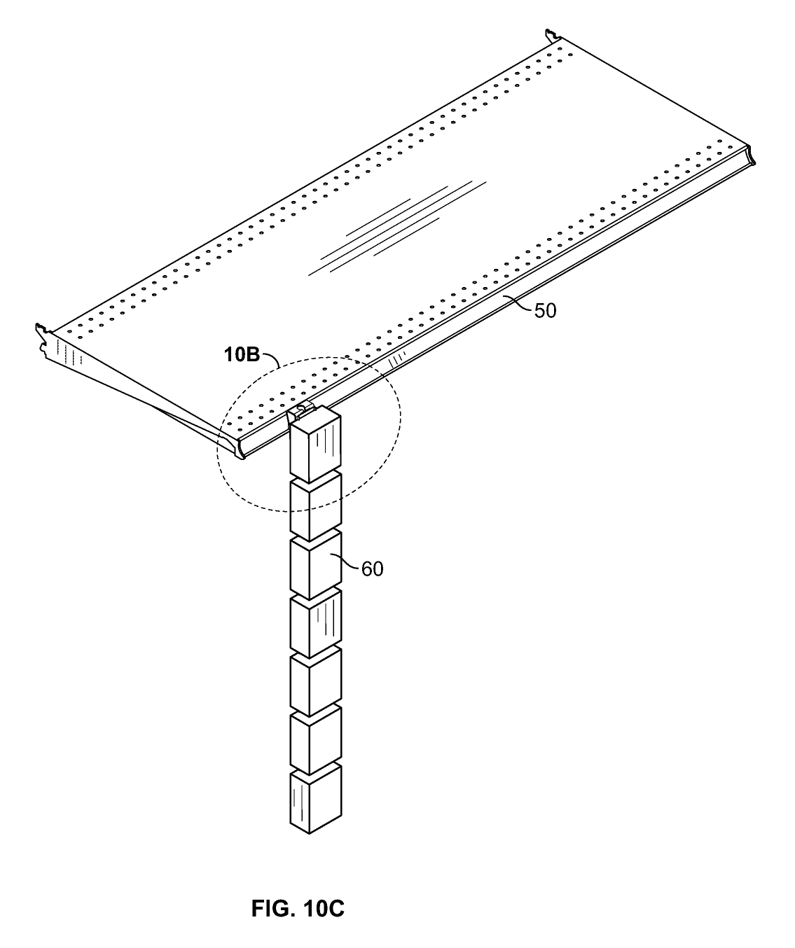

To mount the shelf mounting system 10 to a shelf, the mounting bracket 12 snaps onto a shelf front edge 50, as shown in FIGS. 9-11. The mounting bracket 12 is mounted to the shelf such that a front edge 50 of the shelf rests in the channel 30 of the shelf mounting system 10. The flexible walls 34, 36 are pliable to mount around the shelf edge 50, yet sufficiently rigid to hold the shelf edge 50 in channel 30 when the mounting bracket 12 is positioned onto the shelf front edge 50. It is contemplated that the flexible walls 34, 36 may be biased using hinges or springs or other means to bias the walls 34, 36 around the shelf edge. When the mounting bracket 12 is mounted, the brace wall 38 is positioned along an underside of the shelf, as shown in FIG. 10a. The shelf and/or shelf edge 50 contacts the mounting bracket 12 in at least three points or areas A, B, and C and is movable/slidable along the shelf edge 50. In addition, the mounting bracket is easily removed from the shelf edge 50 and repositionable on another shelf edge.

The gimbal head 18 of the swivel clip 14 slides into the enlarged open region 17 formed as part of the slot 16 of the shelf mounting bracket 12. The head 18 is inserted into the open region 17 and the shaft 19 inserted into the slot 16. In this manner, the clip 14 is secured in the mounting bracket 12 by interference of the head 18 not fitting through the slot 16. The swivel clip 14 is rotatable 360 degrees both clockwise and counterclockwise and can be pivoted in any direction within the slot 16. The swivel clip 14 has a surface 22 to which adhesive or adhesive material is applied for mounting product displays or signage 60 onto the shelf mounting system 10. It is also contemplated that product strips or signage 60 may be suspended from the swivel clip 14.

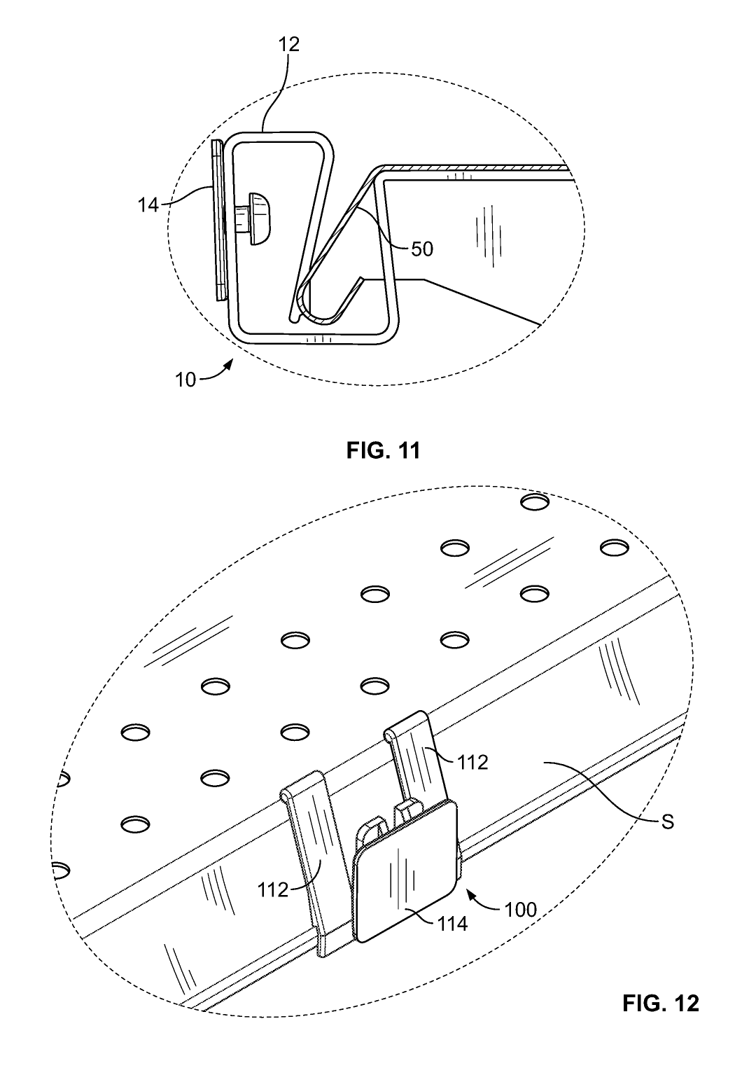

One of the greatest advantages of the present mounting system 10 is that no tools are necessary to mount the mounting bracket 12 to the shelf edge 50 or the clip 14 to the bracket 12. The mounting bracket 12 is configured to mount to any type of shelf, regardless of whether the shelf includes a front channel 51, as in FIG. 10b or does not include a front channel, as in FIG. 11a. The front wall 40 is positioned to allow the product display 60 to be suspended perpendicular to the floor when attached to the swivel clip. The product display or signage 60 is also able to swing and/or rotate, as well as slide laterally along the shelf edge. This feature allows easy access to shelves or price tags located behind the hanging product display, as well as allows product displays to be mounted in a variety of different positions.

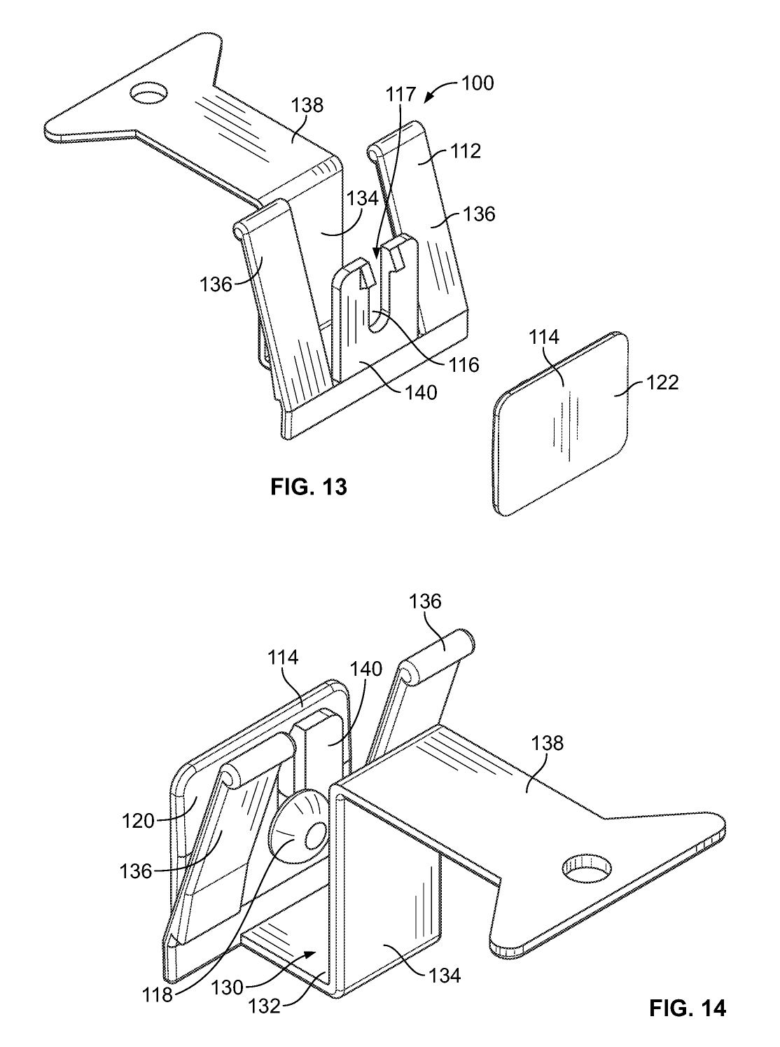

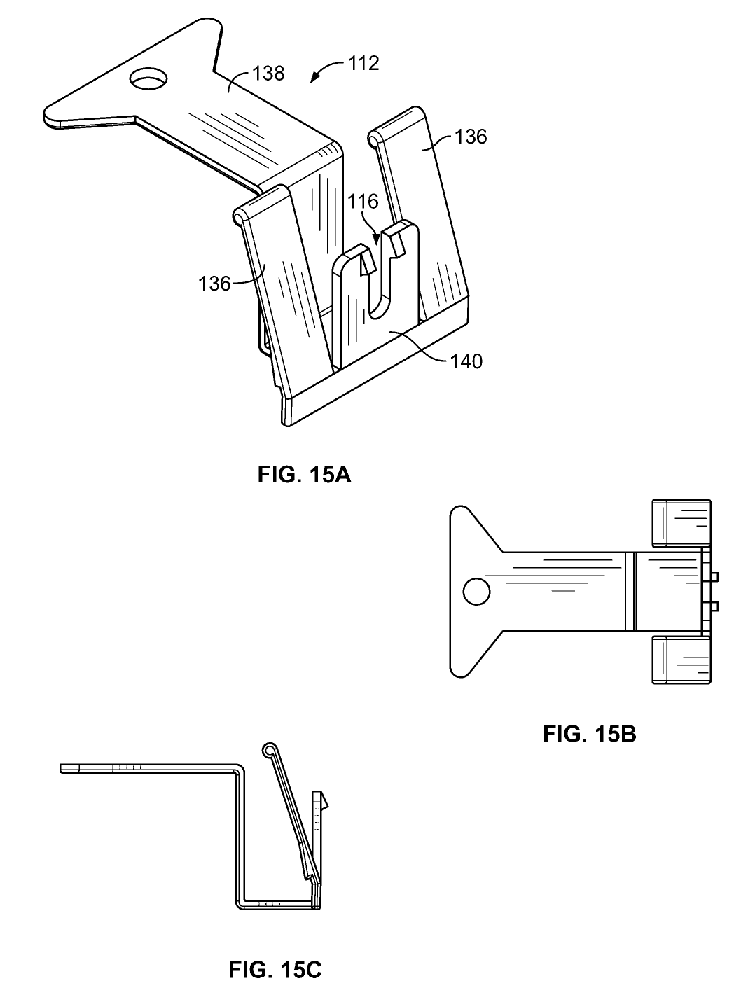

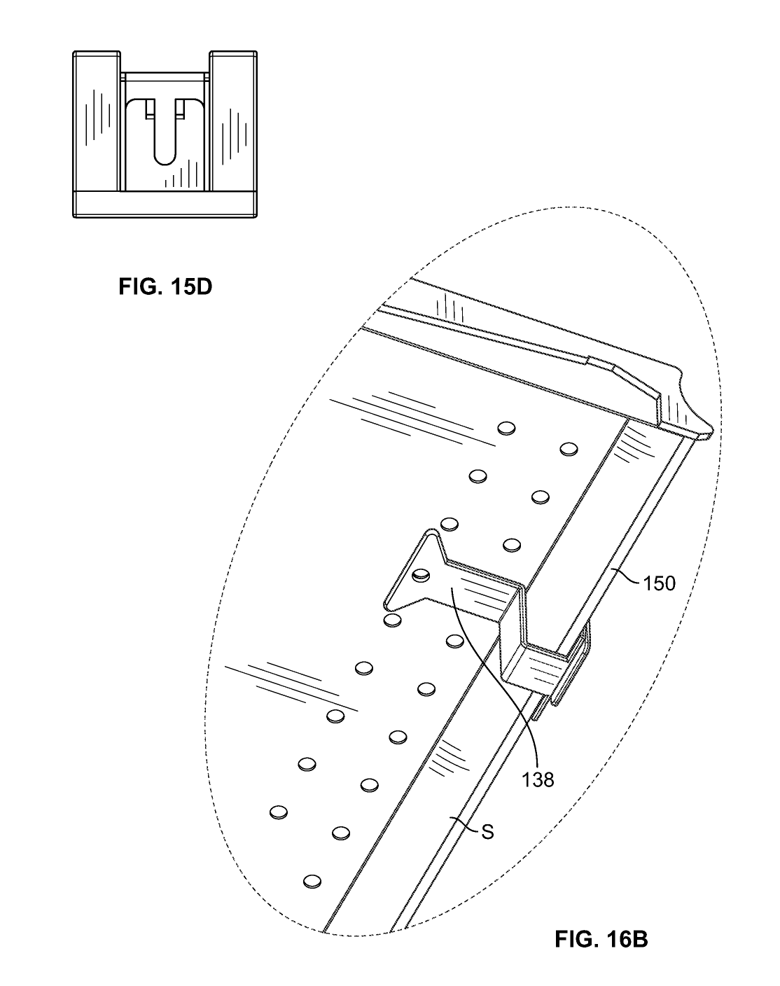

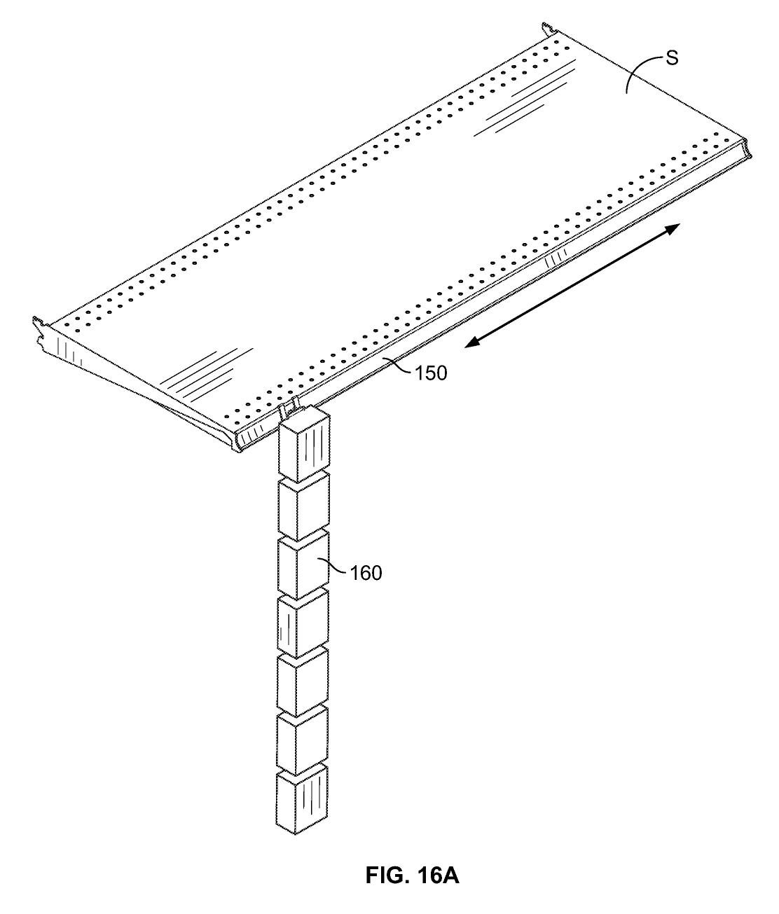

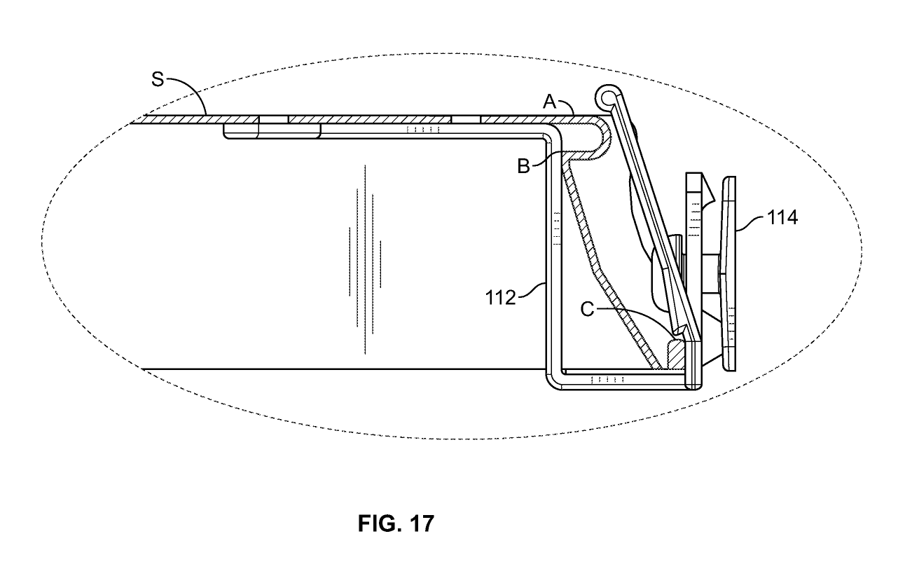

Another embodiment of the present shelf mounting system 100 is shown in FIGS. 12-18. In this embodiment, the mounting bracket 112 includes a channel 130 formed by a base 132 and two flexible walls 134 and 136, and a brace wall 138. A front wall 140 is formed having a slot 116 in which the gimbal head 118 of a swivel clip 144 is positioned. The swivel clip 114 also includes a display wall 120 having an adhesive surface 122 for product display or signage placement. The flexible wall 136 in the present embodiment is bifurcated and the front wall 140 is integral with, yet forward of the flexible wall 136. The mounting bracket 112 is slidable along the shelf laterally and the swivel clip 114 can pivot and rotate 360 degrees both clockwise and counterclockwise within the slot 116.

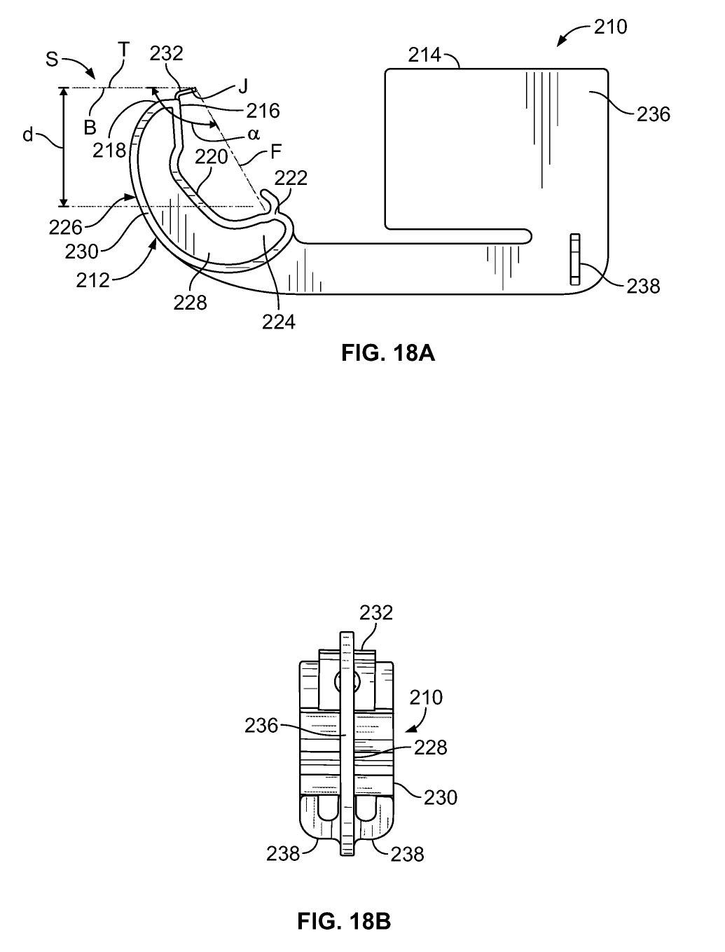

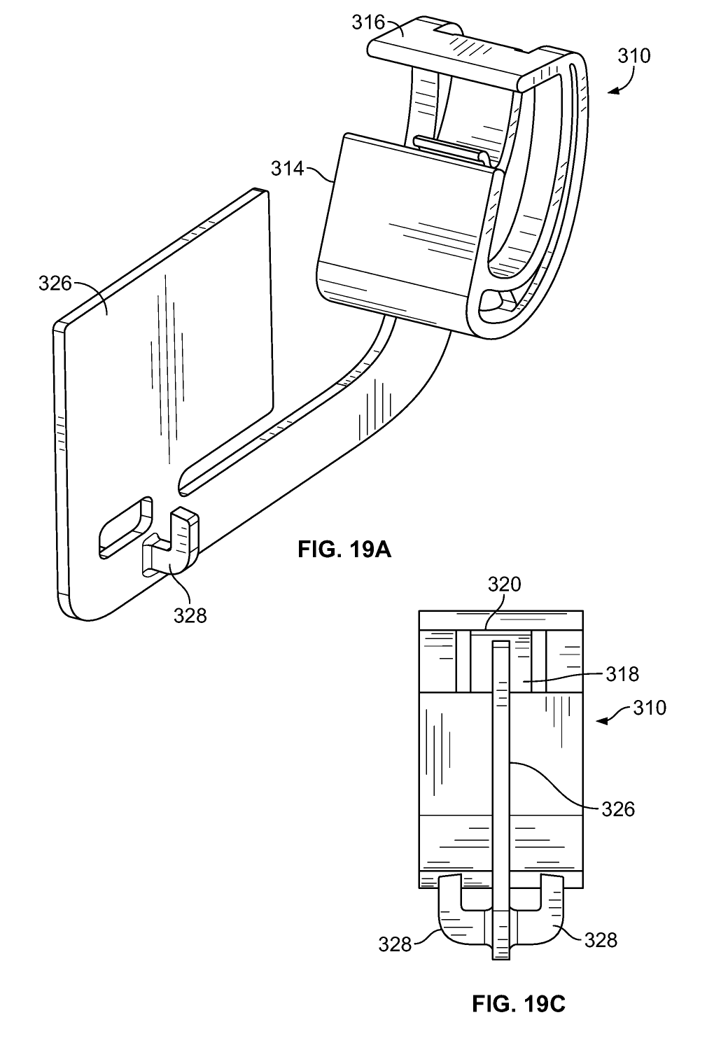

The mounting bracket 112 is mounted to a shelf by snapping the mounting bracket around a shelf edge 150. The mounting bracket 112 is mounted to the shelf such that a front edge 150 of the shelf rests in the channel 130 of the shelf mounting system 110. The flexible walls 134, 136 are pliable to mount around the shelf edge 150, yet sufficiently rigid to hold the shelf edge 150 in channel 130 when the mounting bracket 112 is positioned onto the shelf edge 150. It is contemplated that the flexible walls 134, 136 may be biased using hinges or springs or other means to bias the walls 134, 136 around the shelf edge. When the mounting bracket 112 is mounted, the brace wall 138 is positioned along an underside of the shelf, as shown in FIG. 18. The shelf and/or shelf edge 150 contacts the mounting bracket 112 in at least three points or areas A, B, and C and is movable/slidable along the shelf edge 150. In addition, the mounting bracket is easily removed from the shelf edge 150 and repositionable on another shelf edge.

No tools are necessary to mount the mounting bracket 112 to the shelf edge 150 or the gimbal shaft 119 through the opening 117 and into slot 116. The mounting bracket 112 is configured to mount to any type of shelf, regardless of whether the shelf includes a front channel or does not include a front channel. The front wall 140 is positioned to allow the product display 160 to be suspended perpendicular to the floor when attached to the swivel clip 114. The product display or signage 160 is also able to swing and/or rotate, as well as slide laterally along the shelf edge 150.

Alternate embodiments of the shelf front mount are illustrated in FIGS. 18-21. Each of these embodiments is, like the previously disclosed embodiments, configured to clip or mount to a shelf front to permit the use of signage/displays and mounting product supports (strips and the like), without adversely impacting the ability to use shelf management systems. That is, the mounts are configured to mount to the shelf with points contacting the shelf front lip and shelf bottom surface.

The mount 210 shown in FIGS. 18a and b has an arcuate or C-shaped clip body portion 212 and a display and/or product support portion 214. The clip portion 212 has an upper latch or finger 216 that extends forwardly from about the top 218 of the clip 212 (at about the top of the C). The clip 212 has an open central region 220 and a lower detent 222 that engages the bottom lip L of the shelf front F. The lower detent 222 is at the bottom 224 of the C-shaped body 212. The arcuate body (indicated at 226) of the clip 212 permits the top and bottom (the finger 216 and detent 222) to be flexed away from one another or open, but are maintained closed, by the plastic characteristics (plastic deformation) of the material. That is, the C-shaped body 226 can be urged open, while the resilience of the material returns the clip 212 to its relaxed or formed state. The clip 212 can be formed having a central gusset wall 228 and transversely extending flange walls 230. This strengthens the clip 212 and provides a larger area for contact with the shelf front F and front/bottom surface juncture J.

As seen in FIG. 18a, the finger 216 engages the shelf S at an interior region of the shelf front/bottom surface at a juncture J of the front F and bottom B. This region is behind the shelf front F and along the bottom surface B of the shelf S, and accordingly has no impact on signage that may be mounted to the shelf front F. Because the finger 216 at the top of the clip 212 engages the shelf at the juncture J of the bottom B and front F, it does not infringe on the region of the shelf to which a product management system (not shown) may be mounted.

In the illustrated embodiment, the finger 216 includes an angled member or tip 232 at the end of the finger 216. A metal member 232 is used to provide additional structural strength to the finger 216 and to assure good contact between the finger tip 232 and the shelf front/bottom surface juncture J. The illustrated embodiment is also shown with an outwardly extending flag 236 which can be used to provide many types of information, such as advertising, price information, special/marketing information and the like. One or more integral hooks 238 (for hanging product strips and the like) is formed with the flag 236. It will be appreciated that other types of attachments or ancillary members, other than or in conjunction with the flag 236 can be used. For example, a flat surface (such as that shown in FIGS. 1 and 2) can be used, a single hook, multiple hooks as connector for one or more hanging strips or the like.

It will be appreciated that the clip portion 216 of the mount 210 shown in FIGS. 18a and b is configured for a fairly specific type of shelf. That is, the clip 216 is fairly specifically designed for the length of drop d of the lip L, the angle α of the lip L relative to the shelf S and other specific characteristics.

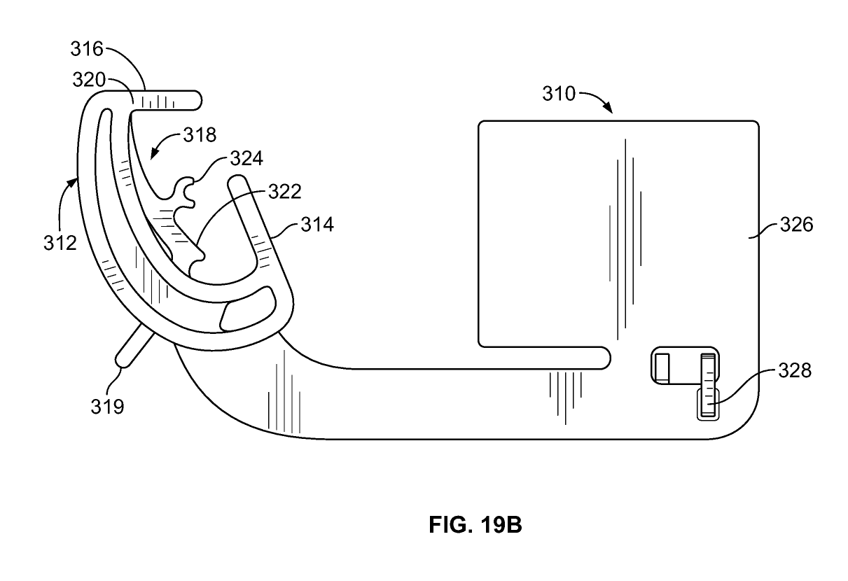

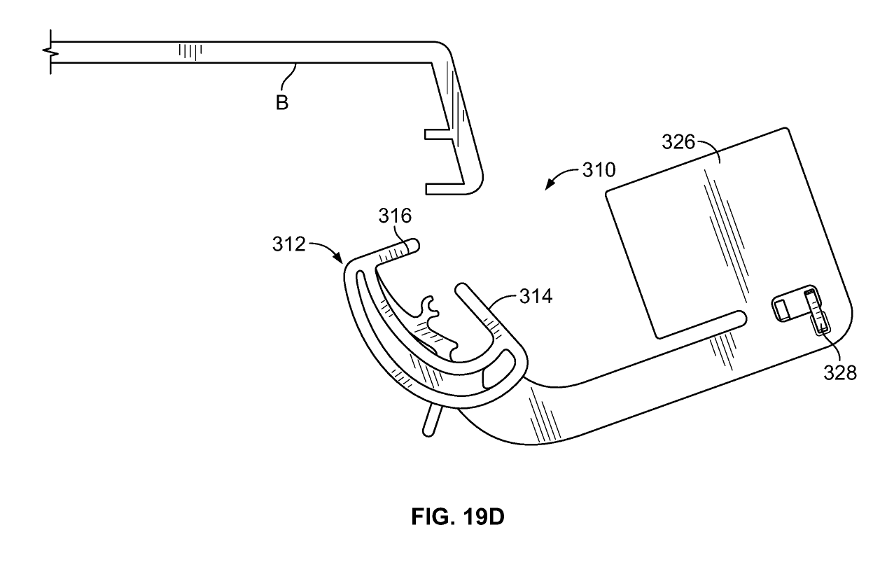

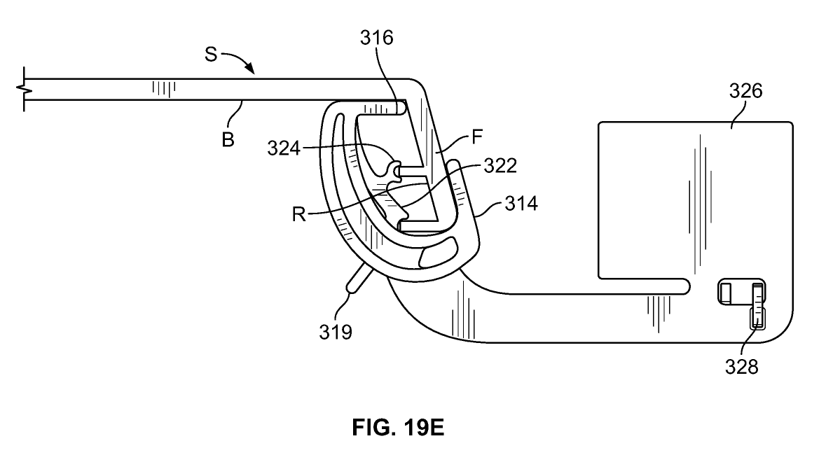

An alternate embodiment of the mount 310 with a locking tab is shown in FIGS. 19a-e. In this embodiment, the clip portion 312 has a lower flange element 314 that is configured to reside over the bottom edge of the lip L and extend upward in front of the lip L (in front of the shelf front F). The clip 312 includes an upper flange 316 that resides on or contacts the bottom surface B of the shelf S at a forward location (near the lip L).

The clip 312 includes an extending flexible tab 318 that is connected to an upper portion 320 of the clip 312 and extends downwardly and rearwardly, and a detent 322 that extends forwardly from the tab 318. The tab 318 and detent 322 can be moved (flexed) between a locking position and a release position. The detent 322 includes a forwardly extending projection 324 to lock into the rear of the shelf front (see FIG. 19e). In this manner, the clip 312 captures the shelf S with the flange 314 at the shelf front F, and the detent 322 locking into the rear R of the shelf front F. The tab 318 can be urged rearward by the finger pull 319 to release the projection 324 from the shelf S for easy removal. Again, this mount 310 is shown with a forwardly extending flag 326 and strip hanging hooks 328, but can include any of a number of other attachments and ancillary members.

In this embodiment 310, the locking feature is provided by capturing the shelf front F between the flange 314 and the projection 324. The upper portion 330 of the clip 312 (the upper flange 316) can rest on the bottom surface B of the shelf S and may insert into the juncture J of the shelf bottom B and the front F. Although the detent 322 and projection 324 are shown integral with the clip portion 312, they can be provided as one or more separate elements (similar to the metal tip member 232 of FIG. 18). However, they are preferably formed integral, as one element, from a polymeric (plastic) material for ease of manufacture and cost savings. One of the benefits of this mount 310 arrangement is that it can be used with various shelf front configurations.

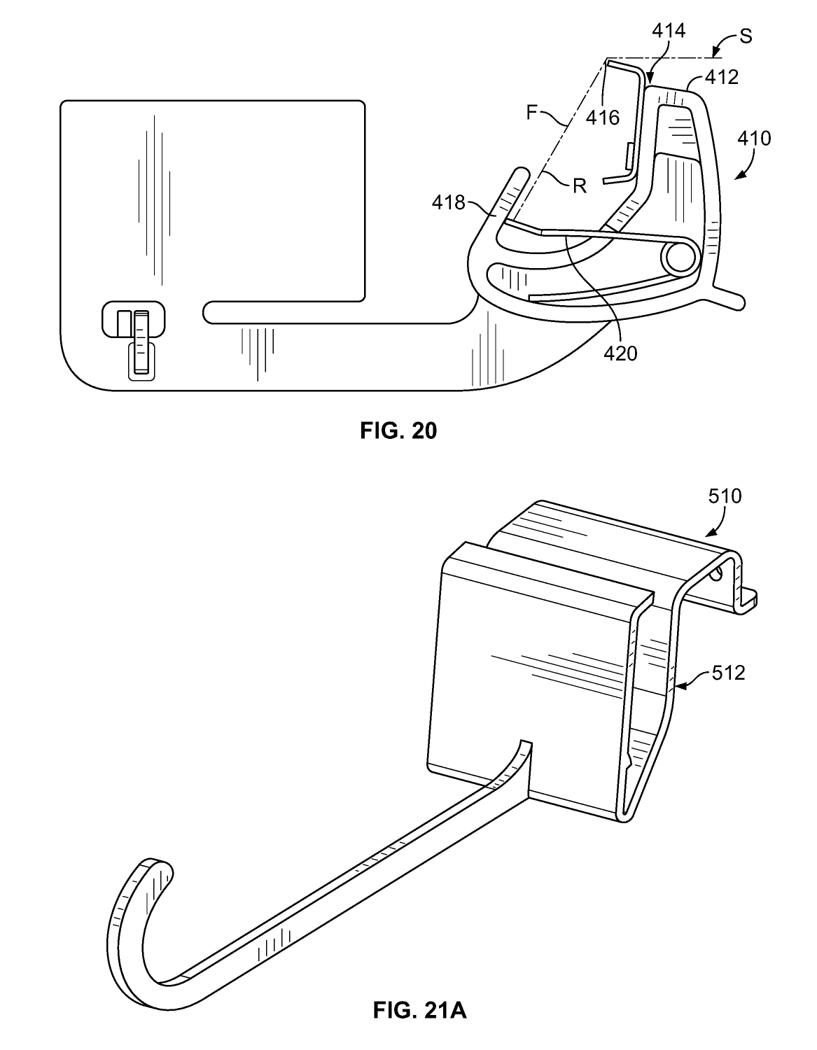

Still another alternate embodiment 410 of the mount is illustrated in FIG. 20. In this embodiment the clip portion 412 includes an upper finger 414, preferably with a metal element or tip 416 and a lower flange 418 for capturing the shelf front F. A lower biasing element 420 such as the illustrated spring engages the rear R of the shelf front F to lock the clip to the shelf front F. Similar to the embodiment of FIGS. 19a-e, this embodiment 410 is configured as a more universal mount in that it can be mounted to a variety of different shelf types and configurations.

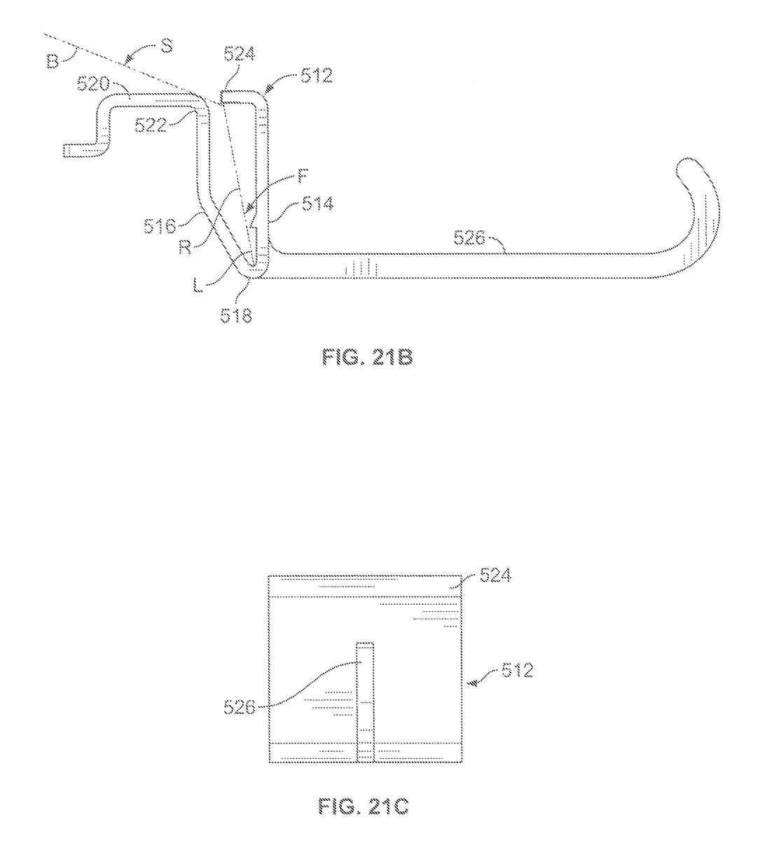

Yet another embodiment 510 of the shelf front mount is illustrated in FIG. 21a-c. In this embodiment, a shelf front clip 512 is configured to capture the front F and rear R of the shelf front F by wrapping around the bottom lip L of the front F. The clip 512 includes a front wall 514 and a rear wall 516 that each extend from a bottom juncture 518 of the clip 512. A flange 520 extends rearwardly from the top 522 of the rear wall 516 to rest on (or engage) the bottom surface B of the shelf S. A lip 524 extends rearwardly from the front wall 514 of the mount 510 to engage the shelf front F/shelf top surface T. A product hook 526 is formed integral with the clip 512, extending forwardly from the front wall 514 of the clip 512.

It will be appreciated that although this embodiment of the mount 510 extends over the shelf front F and onto the shelf top surface T, it extends only a de minimis amount over the shelf top surface T. In that there may be some product management systems that do not extend fully to the front edge of the shelf surface, such a shelf front mount 510 may be acceptable for use with these systems. The clip 512 includes a locking finger 528 that extends inwardly of the wall 514 to secure the mount 510 to the shelf S.

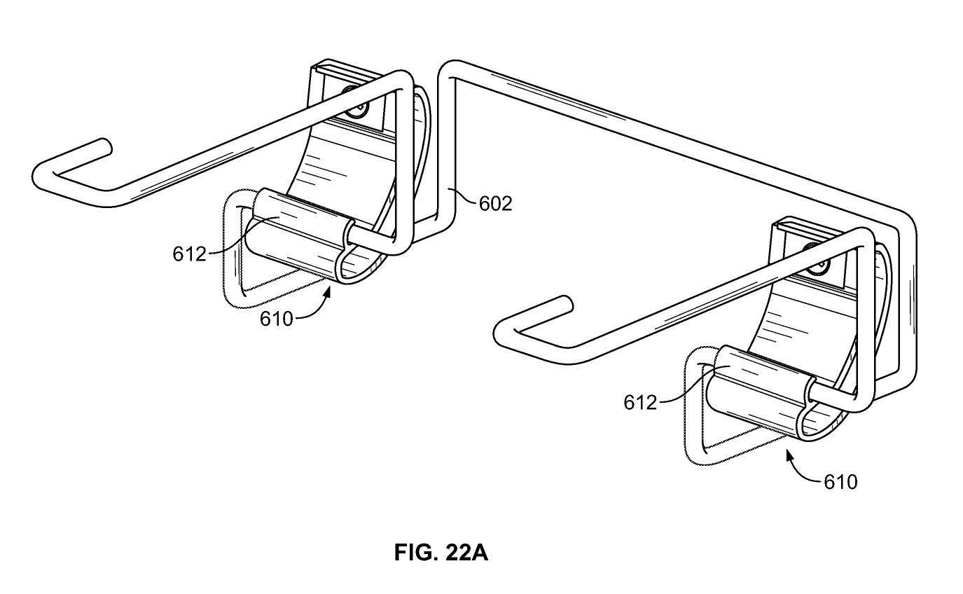

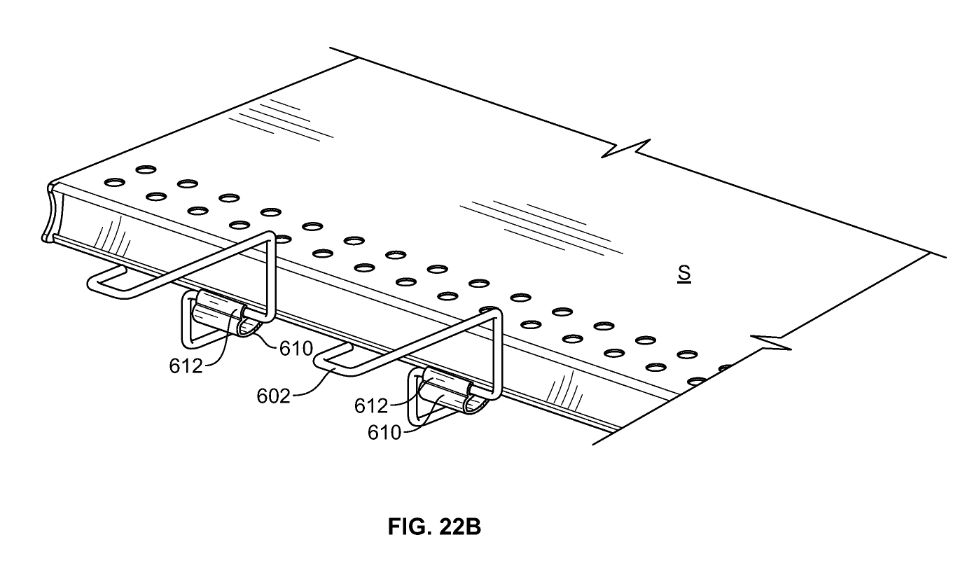

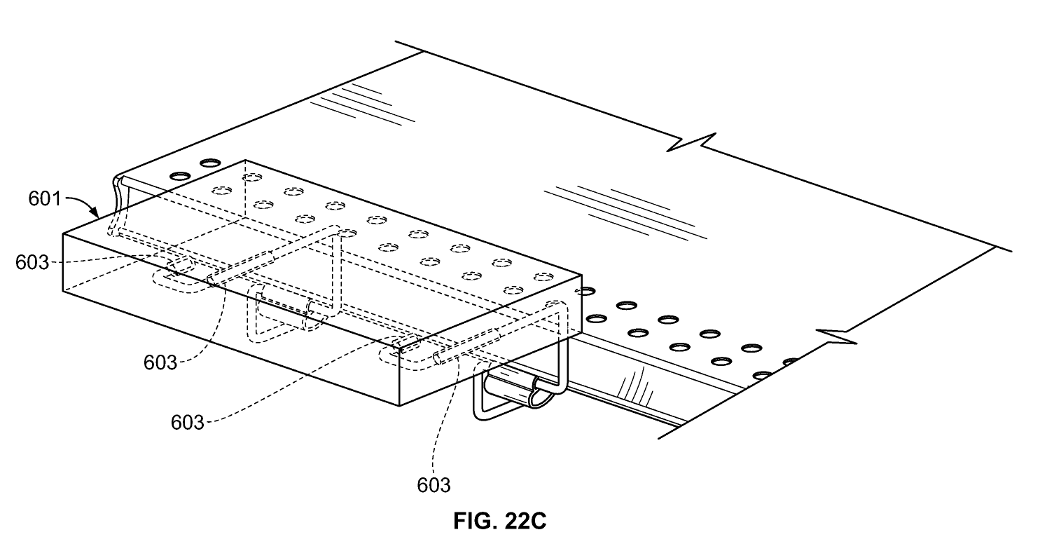

Another type of attachment or ancillary member for the shelf mount is a shelf extender 610 shown in FIGS. 22a-c. Such a shelf extender 601 is configured for attachment to two shelf mounts 610 by rigid steel wire 602 or the like that is clipped onto the shelf mount 610. In one such arrangement, the wire 602 is bent so as to fit into fittings 603 in the bottom of shelf extender 601. The wire 602 then clips into a channel 612 in the shelf mount 610 and then extends around the base 614 of the mount 610 and shelf front F and up to the bottom surface B of the shelf S. The bent rigid wire 602 provides structure and support (leveraging against the bottom B of the shelf S), and is held in place in the channel 612 in the shelf mount 610. The mount 610 structures can be any of those illustrated in the previous embodiments.

Because the shelf extender 601 uses shelf front mounts 610 and wires 602 that lie on the bottom B of the shelf S, the extender 601 can likewise be used with many known product management systems.

As will be appreciated from the above descriptions of the present shelf front mounts, one of the major advantages of the mount is that it works in conjunction with, that is without interfering with, known product management systems (product pushers and the like), while providing advertising and product display (e.g., product support strips) at the shelf front.

All patents referred to herein, if any, are incorporated herein by reference, whether or not specifically done so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

What is claimed is:

1. A shelf front mounting system for use on a shelf having a shelf upper surface, a shelf lower surface and a shelf front depending from a front edge of the shelf at a juncture of the shelf and the shelf front, the shelf front having a lower lip, the mounting system comprising:
a flexible clip portion having an upper finger for contacting the shelf lower surface near the front edge of the shelf and a lower detent for engaging the shelf front at about the lower lip.

2. The shelf front mounting system in accordance with claim 1 including a display portion integral with the flexible clip portion.

3. The shelf front mounting system in accordance with claim 2 wherein the display portion includes a graphics accommodating region.

4. The shelf front mounting system in accordance with claim 1 wherein the flexible clip portion has a C-shaped body.

5. The shelf front mounting system in accordance with claim 1 wherein the mounting system is formed from a polymeric material.

6. The shelf front mounting system in accordance with claim 1 including an angled member mounted to the upper finger for engaging the shelf at about the juncture of the shelf and shelf front.

7. The shelf front mounting system in accordance with claim 3 wherein the graphics accommodating region is formed as a flag.

8. The shelf front mounting system in accordance with claim 7 wherein the flag is vertically oriented and includes one or more hooks formed therein.

9. The shelf front mounting system in accordance with claim 6 wherein the angled member is formed from a metal material.

10. The shelf front mounting system in accordance with claim 1 wherein the clip includes a flange extending from the upper finger.

11. The shelf front mounting system in accordance with claim 1 wherein the clip includes a flange extending from the upper finger and a flange extending from the lower detent, the clip further including a locking tab flexibly connected to the clip portion between the upper finger and the lower detent, the locking clip including a forwardly extending projecting configured to engage and secure to a rear surface of the shelf front.

12. The shelf front mounting system in accordance with claim 1 wherein the clip portion includes a flange extending from the lower detent and a biasing element disposed in the clip between the upper finger and the flange, the biasing member disposed to engage and secure to a rear surface of the shelf front.

13. The shelf front mounting system in accordance with claim 12 including an angled member mounted to the upper finger for engaging the shelf at about the juncture of the shelf and shelf front.

14. The shelf front mounting system in accordance with claim 1 including a shelf extender.

15. The shelf front mounting system in accordance with claim 14 including a pair of clip portions, wherein the shelf extender is mounted to the pair of clip portions and extends forwardly of the shelf.

16. A shelf front mounting system for use on a shelf having a shelf upper surface, a shelf lower surface and a shelf front depending from a front edge of the shelf at a juncture of the shelf and the shelf front, the shelf front having a lower lip, the mounting system comprising:
a flexible clip portion having a front wall and a rear wall integral with and connected to one another at a bottom juncture, the rear wall having an integral flange extending rearward and a from the rear wall and a short rearwardly extending lip extending from the front wall.

17. The shelf front mounting system in accordance with claim 16 wherein the front wall is formed as a display portion.

18. The shelf front mounting system in accordance with claim 16 including a hook formed integral with the front wall and extending forwardly therefrom.

19. A shelf front mounting system comprising:
a bracket configured for mounting on the shelf front and having a channel, at least one flexibly-biased side wall, a brace wall, and a front wall through which a slot is formed;
a detachable swivel clip, the swivel clip having a gimbal head and shaft configured for positioning with the shaft in the slot of the bracket and configured to allow the detachable swivel clip to pivot and rotate within the slot.

20. The mounting system in accordance with claim 19 wherein the bracket is a single-piece molded bracket.

21. The mounting system in accordance with claim 19 wherein the bracket is horizontally or vertically slidable along the shelf front.

22. The mounting system in accordance with claim 19 wherein the bracket and the swivel clip are made from metal, plastic, or a combination thereof.

23. The mounting system in accordance with claim 19 wherein the swivel clip includes a display wall, the display wall having a first surface and a second surface.

24. The mounting system in accordance with claim 23 wherein the gimbal head is mounted to or integral with the first surface of the display wall.

25. The mounting system in accordance with claim 24 wherein the gimbal head is clockwise and counterclockwise rotatable within the slot of the bracket.

26. The mounting system in accordance with claim 23 wherein the second surface of the display wall is an adhesive surface.

27. The mounting system in accordance with claim 19, wherein the flexible walls may be biased using hinges or springs to bias the at least one flexibly-biased wall around the shelf edge.
